(19) United States
(12) Patent Application Publication
(10) Pub. No.: US 2011/0204592 A1
(43) Pub. Date: Aug. 25, 2011

(54) Mobility and Accessibility Device and Lift

(76) Inventors: N. Layne Johansen, Mesa, AZ (US); Casey L. Johansen, Gilbert, AZ (US)

(21) Appl. No.: 13/029,879

(22) Filed: Feb. 17, 2011

Related U.S. Application Data
(60) Provisional application No. 61/305,302, filed on Feb. 17, 2010.

(51) Int. Cl. A61G 5/00; B23P 17/04

(52) U.S. Cl. 280/304.1; 29/401.1

(57) ABSTRACT

Embodiments of the invention provide a mobility device comprising a self-balancing mechanism and at least one wheel operatively coupled to the self-balancing mechanism. A mounting frame can be coupled to the self-balancing mechanism and an outrigger system can be at least partially supported by the mounting frame. In some embodiments, the outrigger system can include a stabilizer handle at least partially supported by the mounting frame, at least one stabilizer link operatively coupled to the stabilizer handle, and at least one stabilizer bracket operatively coupled to the at least one stabilizer link.

### RELATED APPLICATIONS

This application claims priority under 35 U.S.C. §119 to U.S. Provisional Patent Application No. 61/305,302 filed on Feb. 17, 2010, the entire contents of which is incorporated herein by reference.

### BACKGROUND

Mobility and accessibility devices, such as wheelchairs, can provide limited mobility and flexibility for users. For example, some conventional wheelchairs, manual or motorized, have a large footprint with generally four wheels. This can make some conventional wheelchairs substantially inherently wide and bulky with a relatively large turning radius. This can restrict some users from accessing smaller common areas not generally designed to accommodate portions of some wheelchairs, such as an office area or desk.

In addition, at least some motorized wheelchairs can be extremely heavy which can also limit mobility and transportability of the wheelchairs. For example, motorized wheelchair users who drive vehicles, such as trucks, can experience difficulties placing some wheel chairs into the vehicle by themselves. Further, the use of ramps can require the assistance of a second person and some conventional lifting mechanisms do not include the lifting capacity for lifting an electric wheelchair.

### SUMMARY

Some embodiments of the invention provide a mobility device comprising a self-balancing mechanism and at least one wheel operatively coupled to the self-balancing mechanism. A mounting frame can be coupled to the self-balancing mechanism and an outrigger system can be at least partially supported by the mounting frame. In some embodiments, the outrigger system can include a stabilizer handle at least partially supported by the mounting frame, at least one stabilizer link operatively coupled to the stabilizer handle, and at least one stabilizer bracket operatively coupled to the at least one stabilizer link.

Some embodiments of the invention provide a mobility device comprising a self-balancing mechanism and at least one wheel operatively coupled to the self-balancing mechanism. A mounting frame can be coupled to the self-balancing mechanism and a control system can be at least partially supported by the mounting frame. In some embodiments, the control system can include a steering linkage system at least partially supported by the mounting frame, and a steering column directly connected to the self-balancing mechanism and operatively coupled to the steering linkage system.

Some embodiments of the invention provide a method for retrofitting a mobility device. In some embodiments the method can include providing a conventional self-balancing mobility device and removing an element of the conventional self-balancing mobility device. In some embodiments, the element can comprise a self-balancing mechanism and at least one wheel operatively coupled to the self-balancing mechanism. Further embodiments can include coupling a mounting frame to the portion and installing an outrigger system so that a least a portion of the outrigger system is supported by the mounting frame and installing a control system so that at least a portion of the control system is supported by the mounting frame.

### DESCRIPTION OF THE DRAWINGS

FIG. 1 is a front perspective view of a mobility and accessibility device according to one embodiment of the invention.

FIGS. 2A-2D are various views of the mobility and accessibility device of FIG. 1 in an operational position (e.g., an “on” mode).

FIG. 3 is a front perspective view of the mobility and accessibility device of FIG. 1 in a left steering position.

FIGS. 4A-4D are various views of the mobility and accessibility device of FIG. 1 in a stabilized position (e.g., an “off” mode).

FIGS. 5A-5B are side exploded perspective views of a power wheelchair lift, according to one embodiment of the invention, coupled to a truck.

FIGS. 6A-6B are side perspective views of the power wheelchair lift and a mobility and accessibility device.

FIGS. 7A-7B are top perspective views of the power wheelchair lift and the mobility and accessibility device.

FIGS. 8A-8B are more side perspective views of the power wheelchair lift and the mobility and accessibility device.

FIGS. 9A-9D are various views of the power wheelchair lift.

FIG. 10 is a front perspective view of a mobility and accessibility device according to another embodiment of the invention.

FIGS. 11A-11B are perspective views of the mobility and accessibility device of FIG. 10.

FIG. 12 is a perspective view of a power wheelchair lift, according to another embodiment of the invention, coupled to a truck.

FIG. 13 is a perspective view of the power wheelchair lift of FIG. 12.

FIG. 14 is a perspective view a remote control for use with the power wheelchair lift of FIG. 12.

FIG. 15 is a perspective view of the power wheelchair lift of FIG. 12 during use.

FIG. 16 is another perspective view of the power wheelchair lift of FIG. 12 during use.

FIG. 17 front perspective view of a mobility and accessibility device according to one embodiment of the invention.

FIGS. 18A and 18B are a front view and a rear view, respectively, of the mobility and accessibility device of FIG. 17 in a stabilized position (e.g., an “off” mode).

FIGS. 19A and 19B are a front view and a rear view, respectively, of the mobility and accessibility device of FIG. 17 in an operational position (e.g., an “on” mode).

FIGS. 20A-20C are various views of the mobility and accessibility device of FIG. 17 in an stabilized position (e.g., an “off” mode).

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives that fall within the scope of embodiments of the invention.

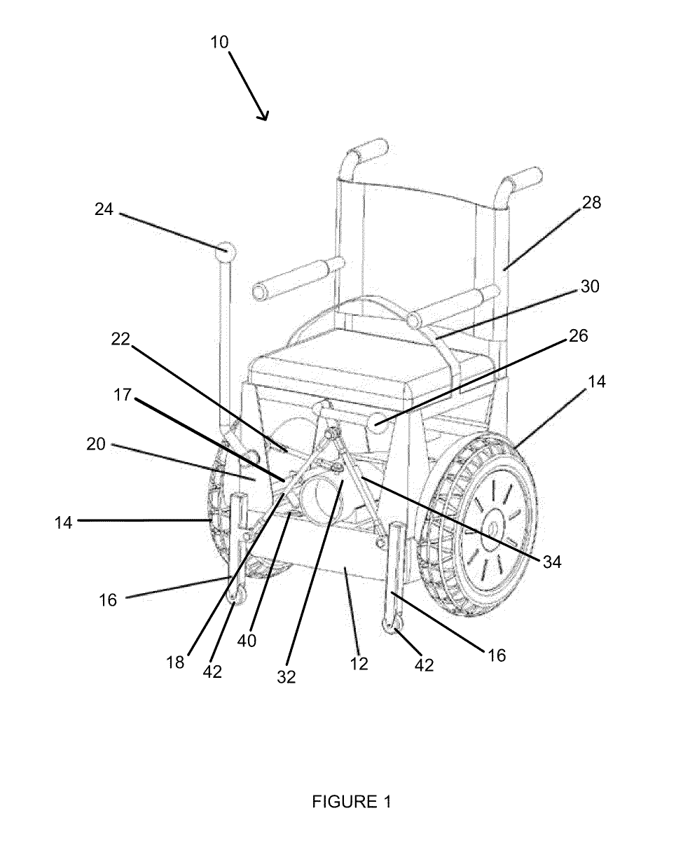

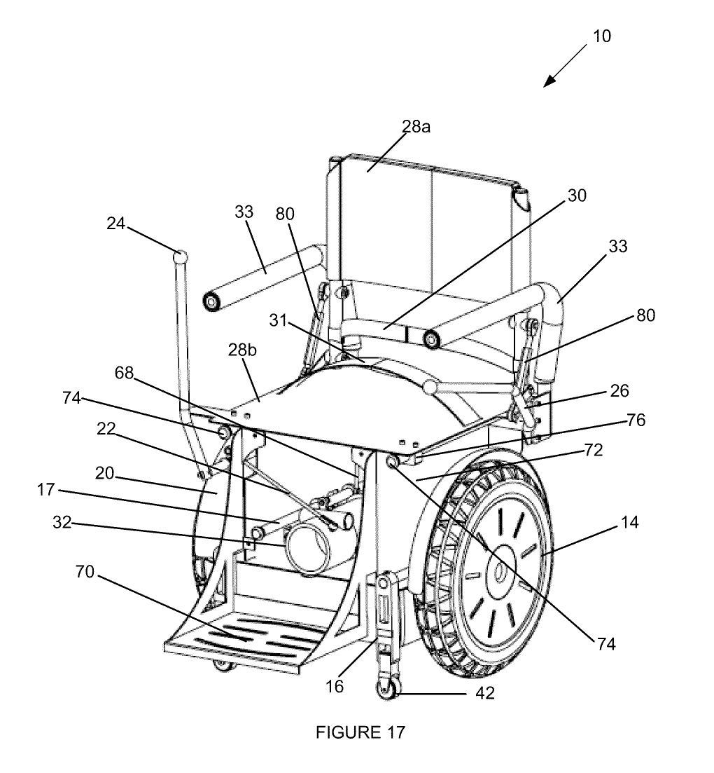

FIGS. 1 and 17 illustrate a mobility and accessibility device 10 according to various embodiments of the invention. The device 10 can be a power driven mobility device and can include a self-balancing mechanism 12, wheels 14, stabilizer brackets 16, stabilizer links 18, a mounting frame 20, one or more steering links 22, a steering handle 24, a stabilizer handle 26, a seat 28, a lifting strap 30, a seat belt 31, and a steering column 32. The device 10 can allow a user to travel in multiple indoor and outdoor applications which can be substantially difficult or generally impossible with conventional mobility devices. In some embodiments, the device 10 can be used by paraplegic individuals or individuals having single or double leg amputations and/or little or no use of one arm. The device 10 of some embodiments can weigh between about 150 pounds and about 175 pounds.

As shown in FIGS. 1 and 17, the device 10 can include the two wheels 14, allowing for improved mobility and flexibility for users compared to conventional four-wheel mobility devices. The self-balancing mechanism 12 can be similar to that included in a Segway® personal transport vehicle or other self-balancing device. In some embodiments, the self-balancing mechanism 12 of some embodiments can be similar to a base portion of the Segway® “i2.” In some embodiments, the self-balancing mechanism 12 can be removed from a self-balancing mobility device and retrofitted with different components, as discussed in more detail below. The mounting frame 20 can be coupled to the self-balancing mechanism 12 and also can support some of the components of the device 10. In some embodiments, the mounting frame 20 can be fixed to the self-balancing mechanism 12 or coupled to the self-balancing mechanism 12 using springs. The fixed mounting frame 20 can add durability, stability, and ease of maintenance (i.e., as one less moving part) to the device 10. As shown in FIGS. 1 and 17, in some embodiments, the mounting frame 20 also can support the seat 28, which can be similar to that of a traditional manually-operated wheel chair and can be coupled to the mounting frame 20. Further, in some embodiments, the device 10 can comprise at least one arm rest 33 removeably coupled to the mounting frame 20. In some embodiments, the arm rest 33 can be removed from the device 10 to reduce the overall size of the device 10 for at least storage, transportation, and user comfort purposes.

The following paragraphs describe the operation and functions of the device 10 according to some embodiments of the invention.

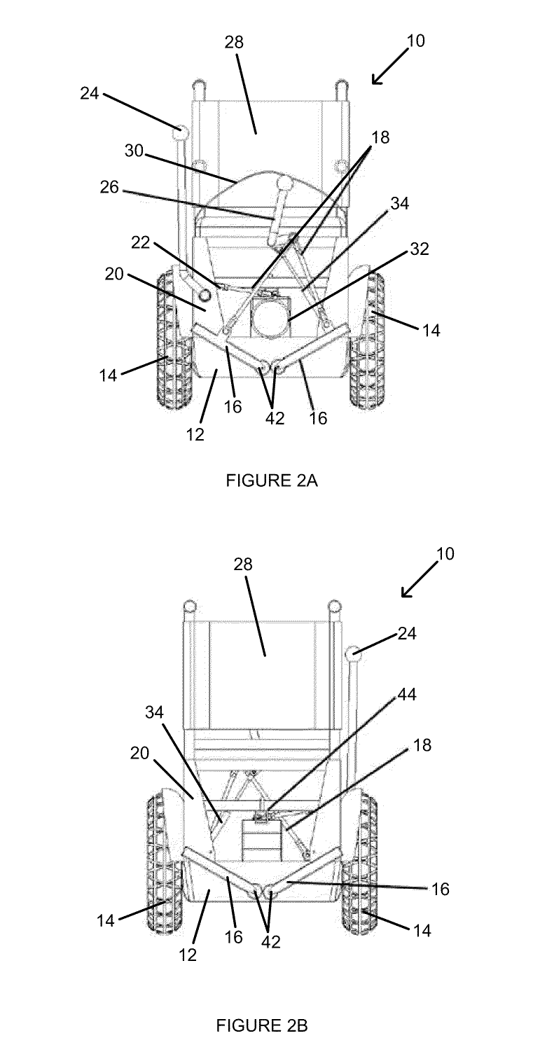

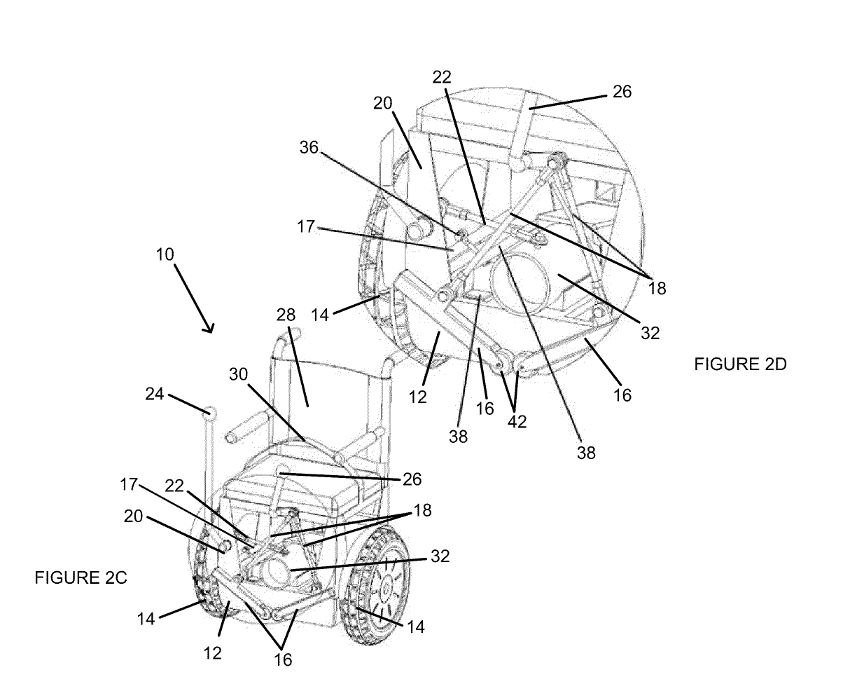

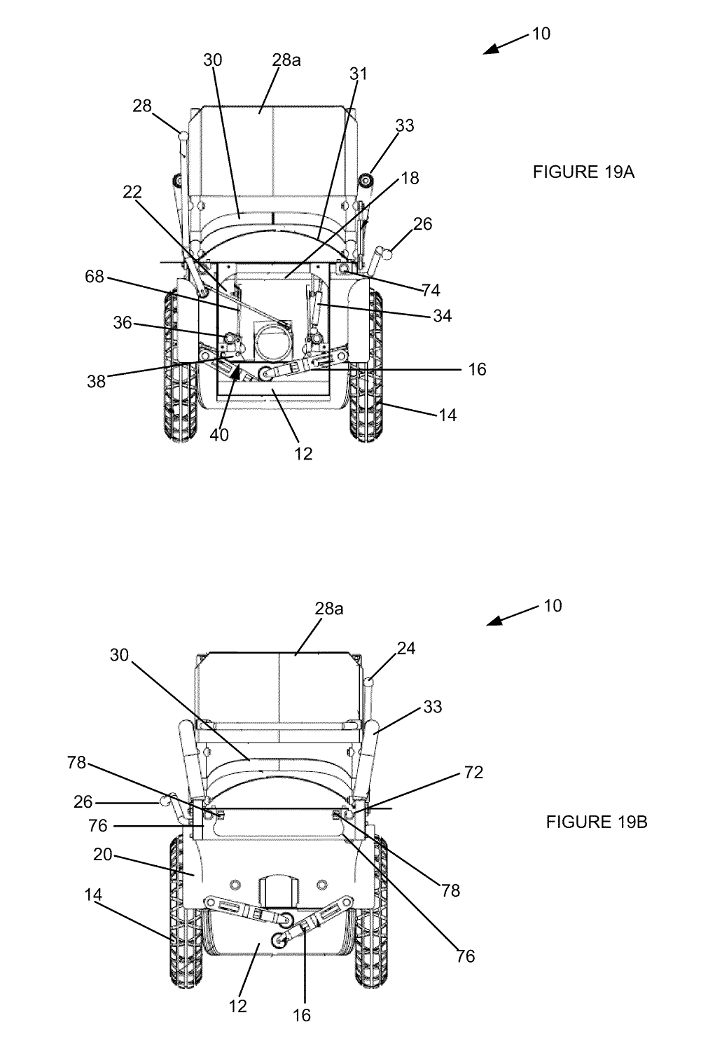

FIGS. 2A-2D and 19A-19B illustrate the device 10 in an operational mode, or “on” position. In order to use the device 10 in the operational mode, a user can sit on the seat 28 and pull the stabilizer handle 26 to a substantially vertical position, as shown in FIGS. 2A and 2C, or push the stabilizer handle 26 in a substantially downward direction, as shown in FIGS. 19A-19B. The stabilizer handle 26 can be operatively coupled to the stabilizer links 18, which, in turn, can be operatively coupled to the stabilizer brackets 16. As a result, moving the stabilizer handle 26 causes the stabilizer brackets 16 to move from a grounded position to an “up” position (i.e., off the ground), as shown in FIGS. 2A-2D and 19A-19B. In addition, a gas strut 34 or hydraulic spring can be coupled to the mounting frame 20 and the stabilizer handle 26, which can assist in the movement of the stabilizer links 18 to move the stabilizer brackets 16 into the up position.

In some embodiments, the stabilizer brackets 16 can include stabilizer shafts 17. For example, each of the stabilizer brackets 16 on each side of the device 10 can be substantially connected together using the stabilizer shaft 17. (i.e., the stabilizer brackets 16 on the right side of the device 10 can be connected through the stabilizer shaft 17). In some embodiments, the stabilizer brackets 16 on each side of the device 10 can be integral with their respective stabilizer shafts 17 so that the two components generally comprise a single element. In other embodiments, the stabilizer shafts 17 can be coupled to the stabilizer brackets 16 using conventional coupling techniques, including fasteners, welding, braising, or similar conventional coupling methods. Additionally, in some embodiments, the stabilizer shafts 17 can transfer at least a portion of the motion applied to the front stabilizer brackets 16, by the stabilizer links 18, to the back stabilizer brackets 16 in order to get the rear stabilizer brackets 16 to substantially synchronously move with the front stabilizer brackets 16. Further, the stabilizer brackets 16 and/or the stabilizer shafts 17 can be operatively coupled to one or more on/off links 36. Further, in some embodiments, the on/off links 36 can move one or more on/off brackets 38 (i.e., via movement of the stabilizer brackets 16) to actuate, engage, or depress on/off switches 40 for the self-balancing mechanism 12. When the on/off brackets substantially actuate the on/off switches 40, the self-balancing mechanism 12 can be in an “on” position to allow motion of the device 10.

In some embodiments, the user can operate the self-balancing mechanism 12 to control forward and backward movement by leaning forward or backward, respectively. More specifically, the two-wheeled self-balancing mechanism 12 can include a plurality of stabilizing sensors and drive motors (not shown) that can detect the user's position and can move the device 10 in a substantially forward and reverse direction as desired. The sensors can detect forward and back body movement to direct forward and reverse movement of the device 10. In some embodiments, the sensors also can detect side to side body movement to direct right and left turning movement of the device 10. In other embodiments, turning, spinning, and side-to-side movement of the device 10 can be substantially controlled by the steering handle 24, as further described below.

According to some embodiments of the invention, the device 10 can include a control system comprising a steering linkage system and the steering column 32. In some embodiments, the control system, including the steering linkage system, can be at least partially supported by the mounting frame 20. In some embodiments, the steering linkage system, can comprise the steering handle 28 and the steering link 22. In other embodiments, the steering linkage system can comprise the steering links 22.

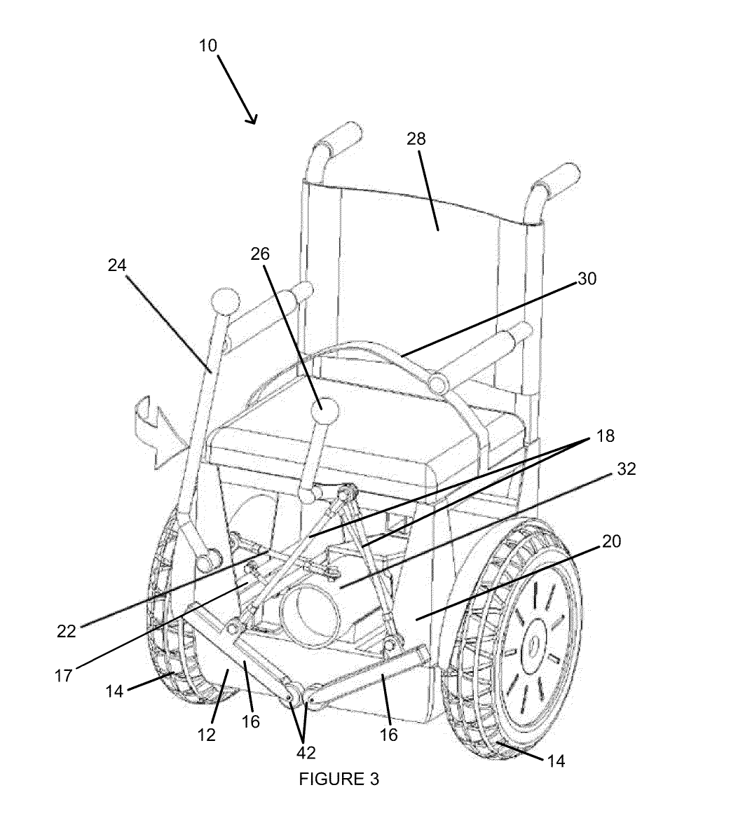

In some embodiments, the user can control left and right rotational motion by movement of the steering handle 24. The steering handle 24, which also can be at least partially supported by the mounting frame 20, can act as a mechanical joystick. The steering handle 24 can be operatively coupled to the steering link 22, which can be operatively coupled to the steering column 32. Movement of the steering link 22, generally via movement of the steering handle 24, can move the steering column 32, which can be directly coupled to the self-balancing mechanism 12. For example, in order to turn left the user can push the steering handle 24 left (as shown in FIG. 3), which can cause movement of the steering link 22, and as a result, turn the steering column 32 which can affect movement by the self-balancing mechanism 12. In some embodiments, the turning operation can provide the user with a generally zero translation turning radius, allowing substantially improved user accessibility to limited-access areas. In some embodiments, the steering handle 24 can allow for single-handed use and can have a minimal range of movement for ease of use in crowded areas. The steering handle 24 can be coupled to either the left or right side of the mounting frame 20 to accommodate right-handed or left-handed users.

In some embodiments, as described above, the steering handle 24 can comprise a rod located on the left or right side of the device 10, depending on the needs of the user. In other embodiments, the steering handle 24 can be positioned generally centrally in the front of the device 10, so that it is between the user's legs. In some embodiments, the steering handle 24 can be directly coupled to the self-balancing mechanism 12, rather than through the steering links 22 and the steering column 32, or to the steering column 32, rather than through the steering links 22. In some embodiments, the steering linkage system can be operatively coupled to the seat 28 so that the user can lean to direct the device 10. For example, the steering handle 26 and/or the steering link 22 can be operatively coupled to the seat 28 so that when the user leans in either the right or left direction, the device 10 can move in the desired direction by using the previously mentioned mechanism (i.e., the steering linkage system moves the steering column which can move the wheels).

In yet other embodiments, the steering handle 24 can be coupled to a small mechanical box (not shown) on a left, right or front side of the device 10. The small mechanical box can include motorized or manual links that can require less range of motion necessary for steering of the device 10 and/or translated motion for ease of steering. For example, front and back movement of the steering handle 24 can be translated to left and right turning movement, respectively, or vice versa. In addition, in some embodiments, the steering handle 24 can be constructed of steel, polyvinyl chloride (PVC) pipe, aluminum, other metals, etc.

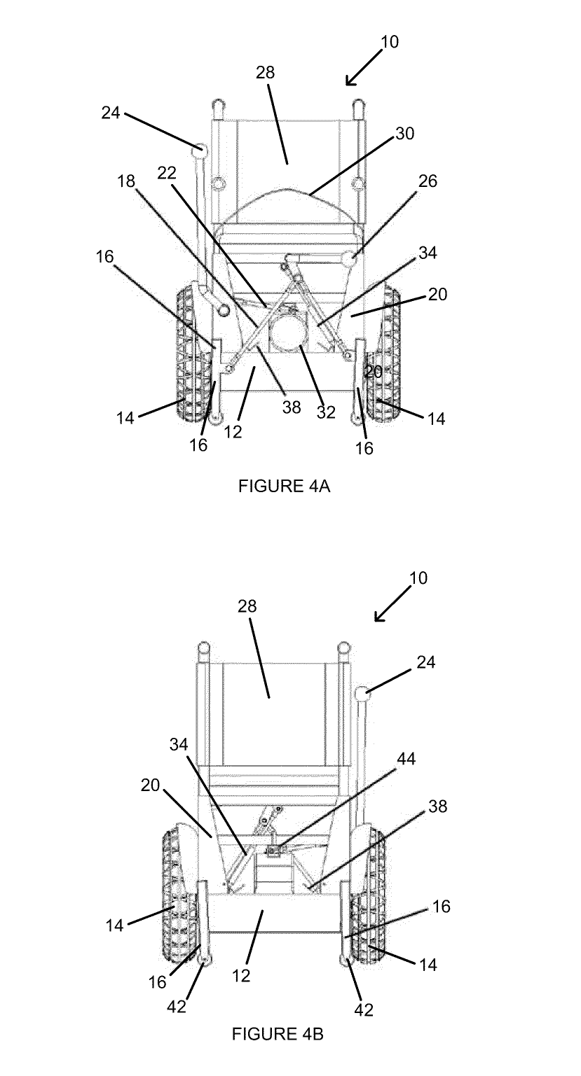

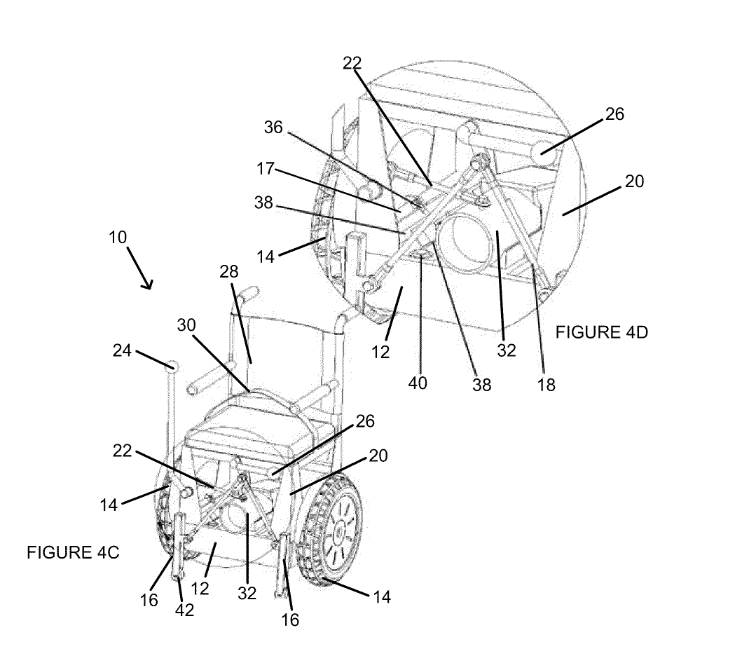

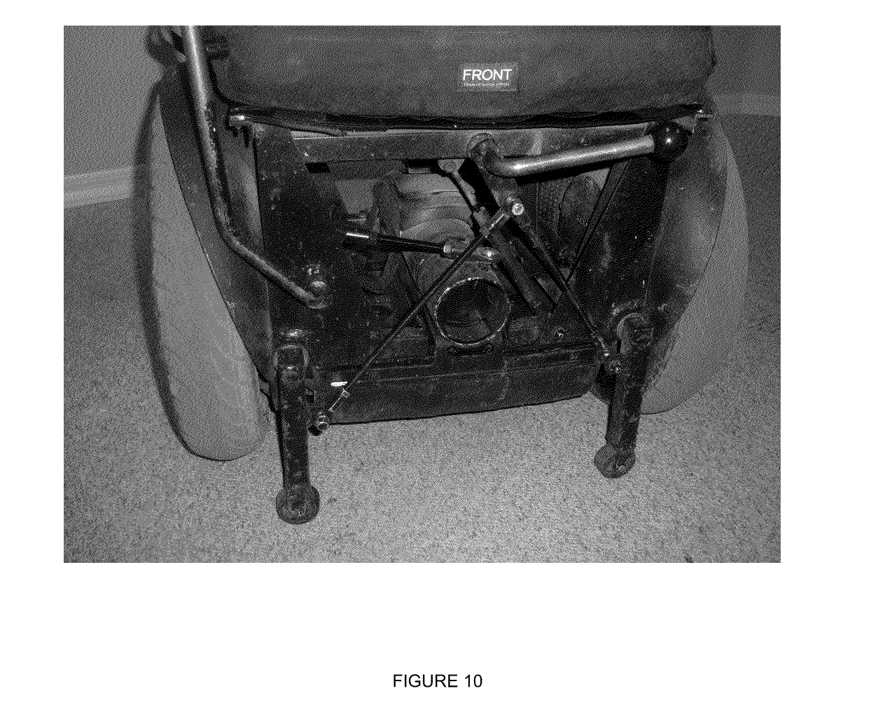

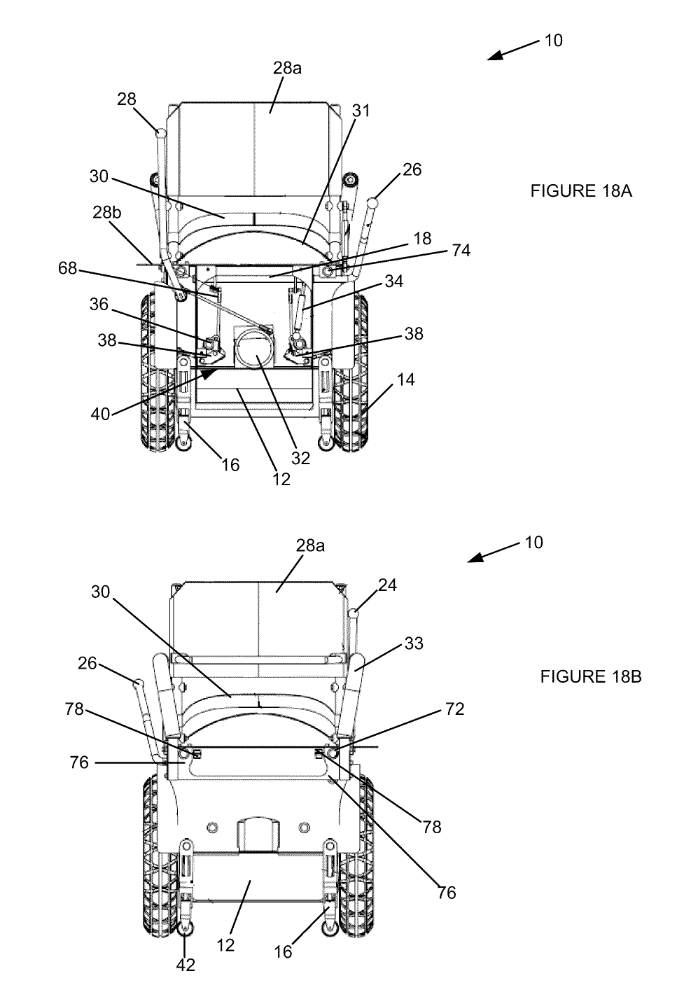

FIGS. 4A-4D and 18A-18B illustrate the device 10 in a stabilized mode, or “off” position. In some embodiments, the device 10 can comprise an outrigger system, which can be at least partially supported by the mounting frame 20. The outrigger system can comprise the stabilizer handle 26, the stabilizer brackets 16, on/off brackets 38, and on/off links 36. In some embodiments, the outrigger system also can comprise the stabilizer shafts 17. In some embodiments, to prevent unwanted motion, the user can place the device 10 in the off position. In order to use the device 10 in the stabilized mode, the user can push the stabilizer handle 26 to a substantially horizontal position, as shown in FIGS. 4A, 4C, and 4D, or the user can pull upward on the stabilizer handle 26, as shown in FIGS. 18A-18B. Moving the stabilizer handle 26 can cause the stabilizer brackets 16 to move from the up position to the grounded position (i.e., touching the ground), as shown FIGS. 4A-4C and 18A-B. Further, by moving the front stabilizer brackets 16, the stabilizer shafts 17 can transfer a portion of that movement to the rear stabilizer brackets 16 to ground those brackets 16 as well. In addition, in some embodiments, the gas strut 34 and/or the hydraulic spring can assist in the movement of the stabilizer links 18 to move the stabilizer brackets 16 into the grounded position. The gas strut 34 and/or the hydraulic spring can allow for both reduced force required to deploy the stabilizer brackets 16 as well as a locking mechanism to secure the stabilizer brackets 16 in place. Further, as described above, the stabilizer brackets 16 and/or the stabilizer shafts 17 can be operatively coupled to the on/off links 36, which can move the on/off brackets 38 (e.g., via movement of the stabilizer brackets 16 and/or stabilizer shafts 17) to actuate, depress, or disengage the on/off switches 40 for the self-balancing mechanism 12. When the on/off switches 40 are disengaged, the self-balancing mechanism 12 can be placed in an “off” position to substantially prevent motion of the device 10, allowing the user to rest in a seated position. FIG. 10 also shows a front view of the device 10, according to one embodiment of the invention, in the stabilized mode.

In some embodiments, as previously mentioned, the outrigger system can be manually powered. When the stabilizer brackets 16 are deployed in the grounded position, they can stabilize the device 10, essentially turning it into a fixed chair and providing stability when the user is mounting or dismounting the device 10. In addition, when the stabilizer brackets 16 are deployed in the grounded position, the device 10 can be powered down, thus saving battery life of the device 10, including the self-balancing mechanism 12. As shown in FIGS. 1-4D and 17-19B, the tips of the stabilizer brackets 16 can be fitted with caster wheels 42 that can allow for ease of deployment and prevent the stabilizer brackets 16 from damaging the surfaces they contact.

Conventional self-balancing mechanisms (such as those for Segway® devices) are set in an operational mode through the use of a spring-loaded frame such that, when a passenger steps on the mechanism, signal buttons are depressed indicating that the mechanism is ready for motion. However, using such settings in the device 10 could cause erratic motion when a user is mounting, dismounting, or adjusting himself in the seat 28. The device 10 includes the outrigger system in the stabilize mode to stabilize the device 10 and prevent such erratic motion during mounting, dismounting, or user adjustment while in the seat 28. In addition, the mechanical outrigger system can be more user friendly than a spring-loaded frame and require little or no maintenance compared to the spring-loaded frame. Also, the self-balancing mechanism 12 can be programmed so that a user can mount the device 10 when it is facing downhill, uphill, or sideways along a slope.

Additionally, in some embodiments, conventional self-balancing mobility devices, such as some Segway® devices, can be retrofitted with an outrigger system and/or a control system to aid in user mounting and dismounting. In some embodiments, the outrigger system can be coupled to the conventional self-balancing mobility device so that the outrigger system can provide stability for the conventional device. In some embodiments, the outrigger system can substantially function as previously described so that a user can use a stabilizer handle to actuate stabilizer brackets, stabilizer links, stabilizer shafts, on/off links, and on/off brackets to generally stabilize the conventional self-balancing mobility device. In some embodiments, by fitting an outrigger system to conventional self-balancing mobility devices, some individuals with difficulty walking, standing, or stabilizing themselves can more assuredly mount and dismount the conventional devices. More specifically, some individuals can more easily mount and dismount the conventional devices because, in lieu of stabilizing the device themselves (i.e., by securing it next to a structure, such as a wall, so that the device will not move during mounting and dismounting), the users can engage the outrigger system before mounting and dismounting, to substantially stabilize the device.

In some embodiments, the device 10 can be completely self-balancing using the self-balancing mechanism 12. In other embodiments, the device 10 can be partially self-balancing, where the self-balancing mechanism 12 provides partial self-balancing capabilities and the device 10 can include additional components to provide mechanical assistance (not shown).

In some embodiments, as previously mentioned with reference to FIGS. 1-4D and 17-19B, the device 10 can include four stabilizer brackets 16, which can further comprise two sets of two stabilizer brackets 16, each connected by stabilizer shafts 17 (e.g., one set on the right side of the device 10 and one set on the left side of the device 10) controlled by the single stabilizer handle 26. In other embodiments, the device 10 can include three stabilizer brackets 16 (e.g., two on one side and one on another side) each controlled by a different stabilizer handle 26 (not shown). In some of these embodiments, each of the three stabilizer brackets 16 can serve as mechanical kick-stands with rubber tips. In yet other embodiments, four stabilizer brackets 16 and a push-button valve (not shown) can be used for the outrigger system. By depressing the push-button valve, compressed air from an onboard tank can be released to four equal air cylinder jacks located at the corners of the device 10 forcing each of the stabilizer brackets 16 (e.g., with rubber tips) to the floor creating a ‘fixed chair.’ The tank can be similar to an air tank used by scuba divers. Other electrical or mechanical (e.g., hydraulic, spring, etc.) assistance systems can be used for deploying the outrigger system in some embodiments. In addition, in some embodiments, the stabilizer handle 26 can be positioned centrally in front of the device 10, as shown in FIGS. 1-4D. In other embodiments, the stabilizer handle 26, or push-button valve, can be positioned on the right side, the left side, or the rear of the device 10. For example, the stabilizer handle 26 or the push-button valve (e.g., for the air cylinder jacks or another mechanical or electrical outrigger system) can be positioned on a small mechanical box, such as the same one described above for the steering handle 24 or an additional one, on the right or left side of the device 10. Also, in some embodiments, as shown in FIGS. 17-20C, the stabilizer handle 26 can be positioned through a side or the rear of the device 10 and can extend forward along either the left or ride side of the device 10 for the user's access.

As shown in FIGS. 17-20B, in some embodiments, the outrigger system can comprise at least two intermediate shafts 68. For example, as shown in FIGS. 18A and 19A, the two intermediate shafts 68 can be substantially positioned at or near the right and left lateral sides of the device 10. In some embodiments, a first end of each of the intermediate shafts 68 can be operatively coupled to a stabilizer link 18, which, in turn, can be operatively coupled to the stabilizer handle 26. Also, a second end of each of the intermediate shafts 68 can be operatively coupled to both the stabilizer shafts 17 and the on/off links 36. As a result, similar to other embodiments of the outrigger system, when the user moves the stabilizer handle 26, the intermediate shafts 68 can transfer the motion to both substantially extend the stabilizer brackets 16 and to turn off the self-balancing mechanism 12, leading to a stabilized device 10. Further, similar to other embodiments, the gas strut 34 can be connected to at least one of the intermediate shafts 68 to aid in activating the outrigger system.

In addition, in some embodiments, the device 10 can include at least one foot mount 70. Also, in some embodiments, the mounting frame 20 can include at least one sidewall 72. In some embodiments, the side wall 72 can protect some of the previously mentioned elements of the device 10 from exposure to potentially harmful forces, such as weather forces. Additionally, the side wall 72 can aid in reducing the amount of debris contacting the internal elements of the device 10. In some embodiments, the side wall 72 can include a plurality of apertures so that many of the previously mentioned elements can extend through the side wall 72.

In some embodiments, the mounting frame 20 and/or the seat 28 can be uniquely positioned for each user to accommodate counterbalances for the user's weight distribution. For example, the device illustrated in FIGS. 1-4D can be developed for a double amputee. However, a user who is a single amputee or who has both legs but not the use of them would have a different weight distribution and can therefore require different positioning of the mounting frame 20 and/or the seat 28. In some embodiments, the mounting frame 20 and/or the seat 28 can be adjustable as described in further detail below.

As shown in FIG. 17-19, in some embodiments, the seat 28 can be generally adjustable and moveable. In some embodiments, the seat 28 can comprise a generally vertical seat portion 28a and a generally horizontal seat portion 28b. In some embodiments, at least two seat-mounting structures 74 can be coupled to the mounting frame 20 and at least two adjustable members 76 can be moveably coupled to the seat-mounting structures 74. In some embodiments, the seat-mounting structures 74 can comprise at least two support rods coupled to the mounting frame 20 to at least partially support the generally horizontal seat portion 28b so that the horizontal seat portion 28b can be adjusted. The moveably coupled adjustable members 76 can be coupled to the generally horizontal seat portion 28b. In some embodiments, the adjustable members 76 can be coupled to the horizontal seat portion 28b using conventional fasteners, such as screws, bolts, etc. For example, in some embodiments, the adjustable members 76 and the seat portion 28b can be moved or slid along the seat-mounting structures 74 to adjust positioning of the horizontal seat portion 28b for user comfort and device 10 balance. Once the horizontal seat portion 28 reaches a desired position, it can be substantially locked into the desired position with a locking mechanism 78 so that the horizontal seat portion 28b can remain in substantially the same position. As a result, the seat 28 can be generally adjustable to more closely conform to different users relatively unique body dimensions.

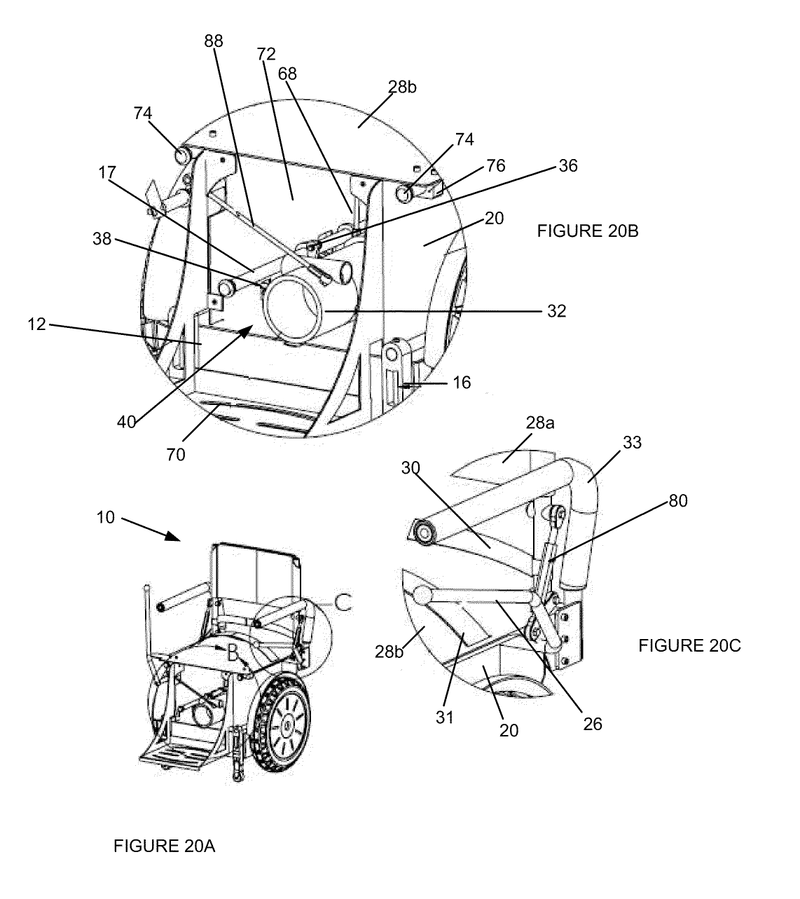

In some embodiments, the generally vertical seat portion 28a also can be generally moveable and adjustable. In some embodiments, the vertical seat portion 28a can be moveably coupled to the mounting frame 20. More specifically, as shown in FIG. 20C, the vertical seat portion 28a can moveably connect to the mounting frame 20 so that the vertical seat portion 28a can generally move from a substantially vertical position (i.e., when the device 10 can be ready for use) to a generally horizontal position (i.e., when the device 10 can be generally ready for transport, storage, non-use, etc.). In some embodiments, the user or another person can move the vertical seat portion 28a by generally actuating the seat portion 28a in either a generally upward or downward direction, depending on the desired result. Further, by being able to move and adjust the seat portion 28a, the user can more easily store and transport the device 10 by reducing its overall height.

In some embodiments, the generally vertical seat portion 28a can comprise a generally reclining position. In some embodiments, as previously mentioned, the generally vertical seat portion 28a can moveably connect to the mounting frame 20. Further, in some embodiments, the moveable connection between the vertical seat portion 28a and the mounting frame 20 can comprise an angular joint, including an adjustable seat link 80. For example, in some embodiments, after the generally vertical seat portion 28a is positioned in a substantially vertical position and the user positions themself in the device 10, the user can substantially actuate the vertical seat portion 28a in a generally backward direction (i.e., the user can lean backward), which can cause the angular joint and the adjustable seat line 80 to expand to support the user. As a result, the seat portion 28a can recline to suit the users needs. In some embodiments, the device 10 can substantially lack a seat 28 so that a user can balance themself on either the foot mount or other portions of the device 10, such as the mounting frame 20. In some of these embodiments, the device 10 can be used in a substantially similar manner described above (i.e., stabilizing the device 10 with an outrigger system and controlling a direction of the device with the control system).

In some embodiments, the device 10 can have a top end speed of about 12 miles per hour (MPH). In some embodiments, the two wheels 14, the self-balancing mechanism 12, and the control system provide the device 10 with a zero turn radius, improved mobility in crowds, smaller dimensions and significantly less weight compared to conventional mobility devices, and all with virtually no noise produced by the device 10.

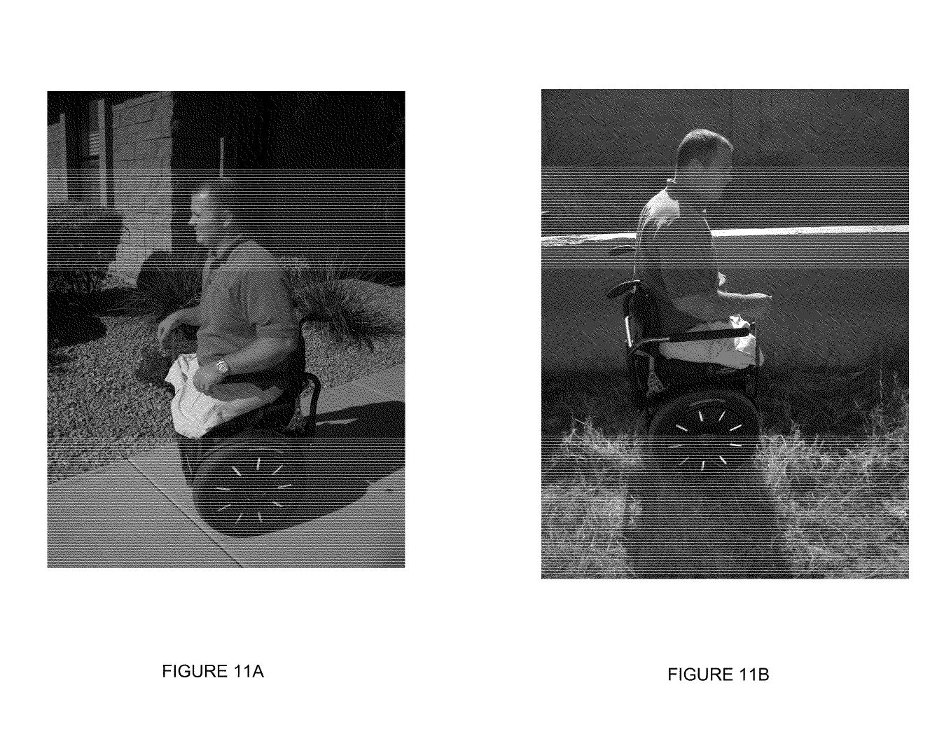

FIGS. 11A-11B illustrate the device 10, according to one embodiment of the invention, on two different terrains. The device 10 can have all-terrain abilities, including successful motion across dirt, gravel, slopes, grass, uneven surfaces, etc., where conventional mobility devices would have much difficulty operating. For example, the device 10 can allow for travel on both front and cross sectional slopes that far exceed allowances required by the Americans with Disabilities Act Accessibility Guidelines (ADAAG), greatly expanding the distances and locations of travel for disabled users. Further, while the device 10 is small enough to maneuver in a crowd, the wheels 14 are large enough to overcome obstacles that would halt traditional mobility device travel, such as train tracks at sidewalk locations, elevator gaps, rocks, loose gravel, bumps, dirt roads, going off curbs, etc. Because of the all-terrain abilities, the device 10 can be used for outdoor recreational applications, such as hiking and camping as well as indoor recreational applications, such as disabled basketball leagues.

In some embodiments, the device 10 can also include interchangeable wheels 14 for different applications. For example, “beach tires” or “track tires” can be interchanged on the device 10 depending on the terrain the user plans to be traveling across. In some embodiments, the device 10 can include adjustable stabilizer brackets 16, as shown in FIGS. 17-20C. In some embodiments, the adjustable stabilizer brackets 16 can comprise a spring-loaded feature so that the user can calibrate the length of the stabilizer brackets 16 to the potentially different dimensions of each of the different types of tires previously mentioned. For example, in some embodiments, after changing tire types, the user can deploy the stabilizer brackets 16 using the stabilizer handle 26, and if the stabilizer brackets 16 are not of a size to stabilize the device 10, the user can activate the spring-loaded feature to adjust the length of the stabilizer brackets 16 to stabilize the device 10. In some embodiments, the adjustable stabilizer brackets 16 can comprise other adjustable features to accomplish adjusting the length, such as, but not limited to, threaded features, hydraulic features, or other similar features.

In addition, in some embodiments, the device 10 can include a trailer hitch 44, as shown in FIGS. 2B and 4B. The trailer hitch 44 can be used pulling a trailer or attaching another accessory device such as a basket. The trailer hitch 44 can be coupled to the mounting frame 20.

In some embodiments, the device 10 can also include the lifting strap 30. The lifting strap 30 can be used to assist in transporting the device 10. The lifting strap 30 can be securely coupled to the mounting frame 20 (which can be permanently coupled to the self-balancing mechanism 12). In one embodiment, the lifting strap 30 can be a thin nylon strap secured to the mounting frame 20 over the seat 28 to allow hoisting of the device 10 by a lift or crane, as described below.

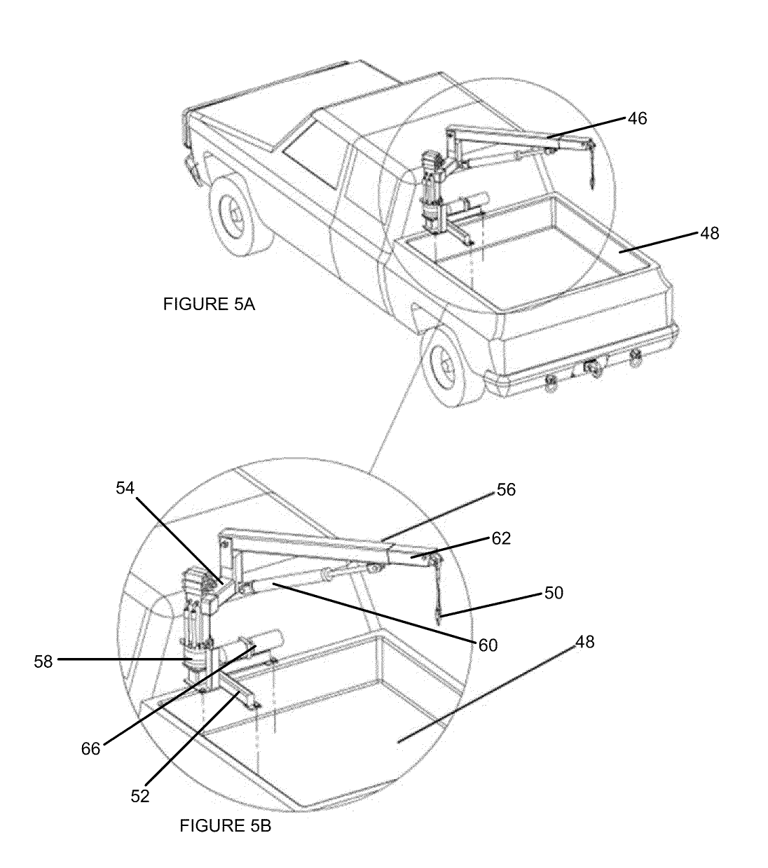

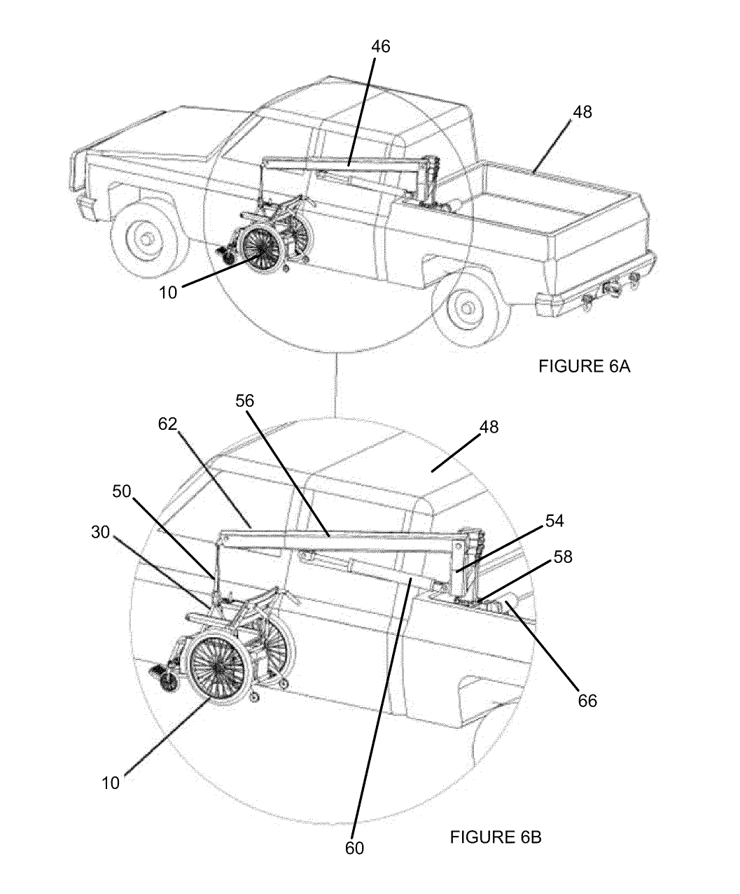

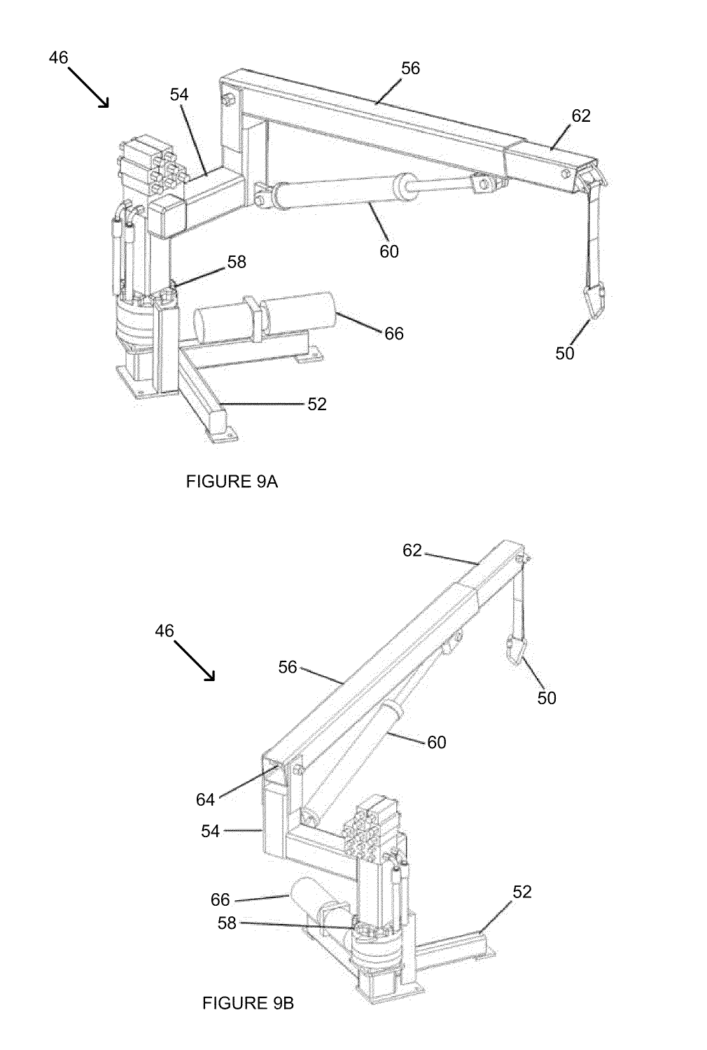

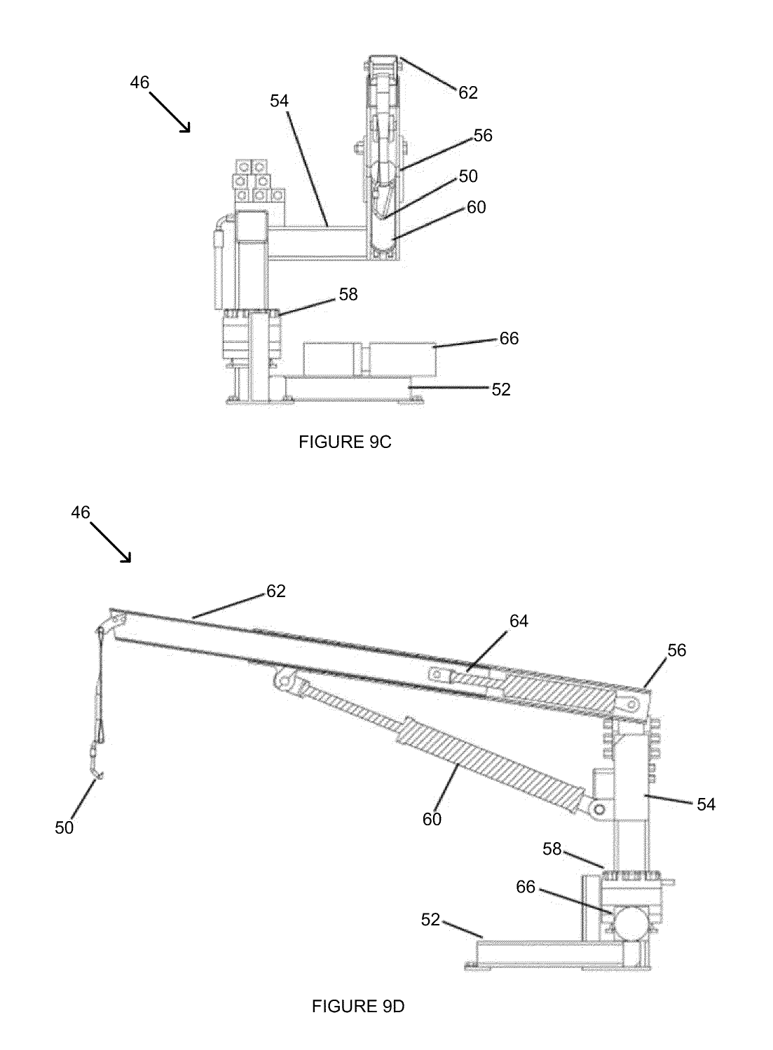

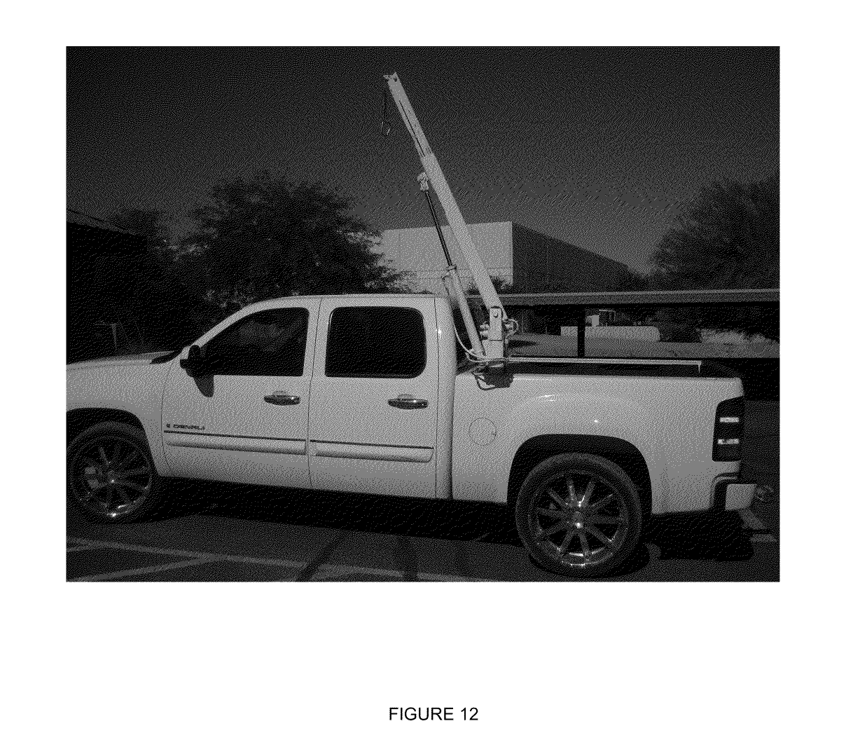

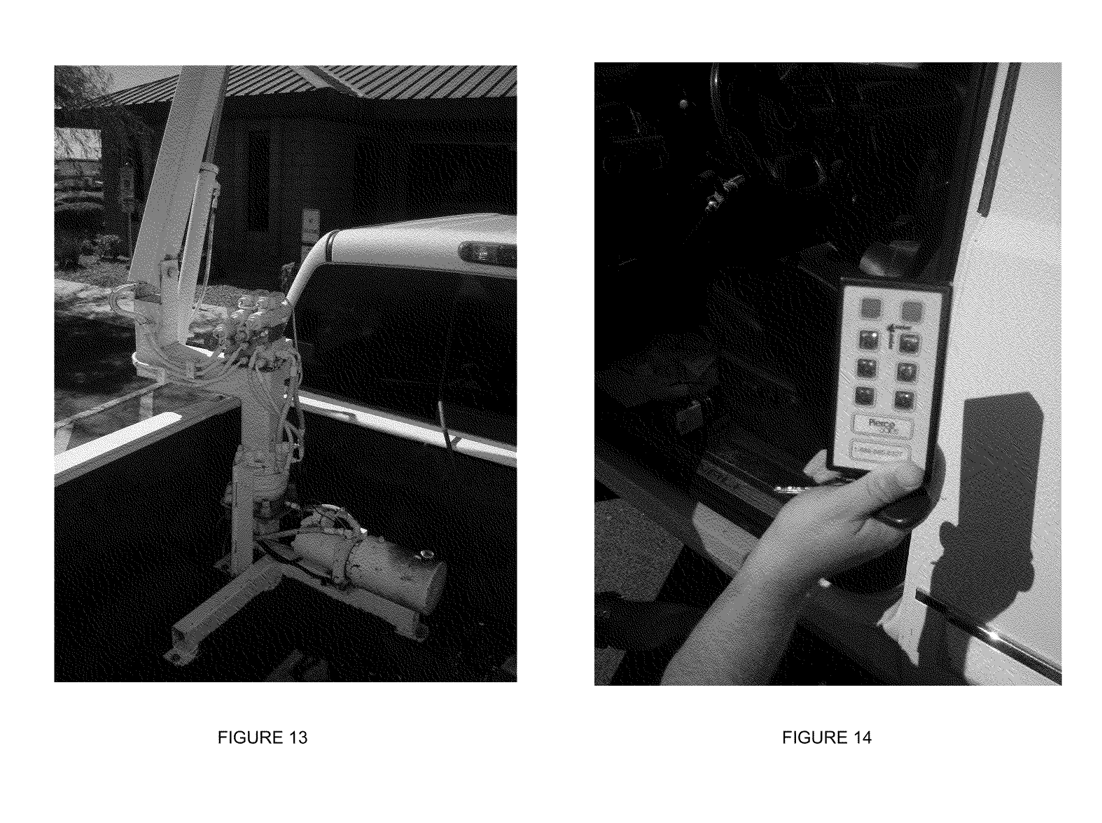

As shown in FIGS. 5A-5B and 12-14, some embodiments of the invention provide a power wheelchair lift 46 to assist the handicapped in being able to enter and exit their vehicle (e.g., a pickup truck 48) and travel with their mobility device 10 without the assistance of other individuals. The lift 46 can be a truckbed-mounted light duty crane designed to pick up the driver's mobility device 10, allowing the driver to enter and exit the truck 48 without assistance, as shown in FIGS. 6A-8B. As shown in FIGS. 9A-9D, the lift 46 can include a connection hook 50, a base frame 52, an upper support arm 54, a boom 56, a hydraulic rotary drive 58, an elevation hydraulic cylinder 60, a boom extension link 62, an extension hydraulic cylinder 64, and a hydraulic power unit 66. The lift 46 can use electric power from the truck 48 and hydraulic power to mobilize the swivel-mounted, extending boom 56. The lift 46 can be controlled by the user with an electronic remote control (as shown in FIG. 14).

In some embodiments, the base frame 52 of the lift 46 can be secured a bed and frame of the truck 48 with bolts. The base frame 52 can provide structural support for the weight of the mobility device 10, the upper support arm 54, the boom 56, and hydraulics of the lift 46 (e.g., the hydraulic rotary drive 58, the elevation hydraulic cylinder 60, the extension hydraulic cylinder 64 and the hydraulic power unit 66). In some embodiments, the base frame 52 can be constructed of steel.

In some embodiments, the base frame 52 can also be coupled to the hydraulic rotary drive 58. The hydraulic rotary drive 58 can be a hydraulic motor that allows an upper portion of the lift 46 to rotate about the base frame 52. The hydraulic rotary drive 58 can be coupled to the upper support arm 54. The upper support arm 54 can be constructed of steel and can provide structural support for the weight of the mobility device 10, the boom 56, and the hydraulics. In addition, the upper support arm 54 can be coupled to the elevation hydraulic cylinder 60, which can allow the boom 56 to elevate.

The extension hydraulic cylinder 64, as shown in FIG. 9D can be positioned inside the boom 56 and coupled to the boom extension link 62 to increase an effective boom length when necessary. The boom extension link 62 can be coupled to the connection hook 50. The connection hook 50 can be temporarily coupled to a lifting strap 30 of the mobility device 10, thus allowing the mobility device 10 to be carried and moved by the lift 46, as shown in FIGS. 6A-8B.

In some embodiments, a power source can be used to power the lift 46 and can be stored inside or on the truck. In some embodiments, the power source can be an auxiliary battery mounted and stored under the hood of the truck. Also, the power source can be connected to the alternator of the truck, and thus, the power source can automatically recharge while the truck is operating. In some embodiments, the power source can be the hydraulic power unit 66, which can be used to power the extension hydraulic cylinder 64 to extend and retract the boom extension link 62, the hydraulic rotary drive 58 to swivel the lift 46 about the base frame 52, and the elevation hydraulic cylinder to lift the boom 56. Pressure reducers can be installed on the hydraulic power unit 66 to slow the speed of the extension, retraction, swivel, and/or elevation.

The following paragraphs describe a method of use for the lift 46, according to one embodiment of the invention. As described in the following paragraphs, the lift 46 can be used by the user of the mobility device 10 (i.e., the driver of a truck 48) to place the mobility device 10 on the truck 48 without the assistance of a second user.

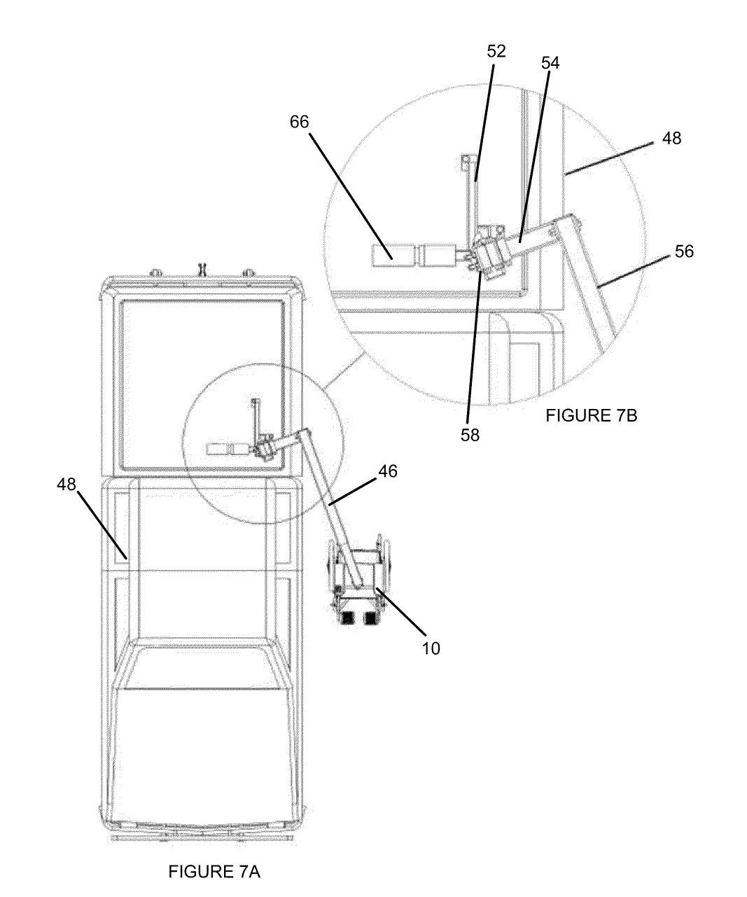

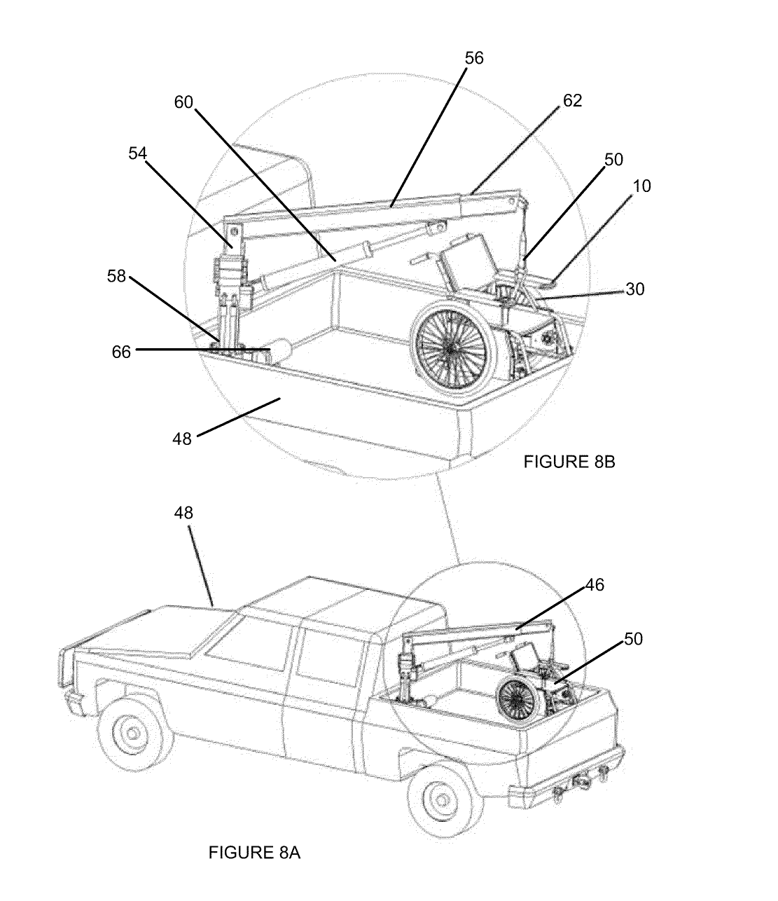

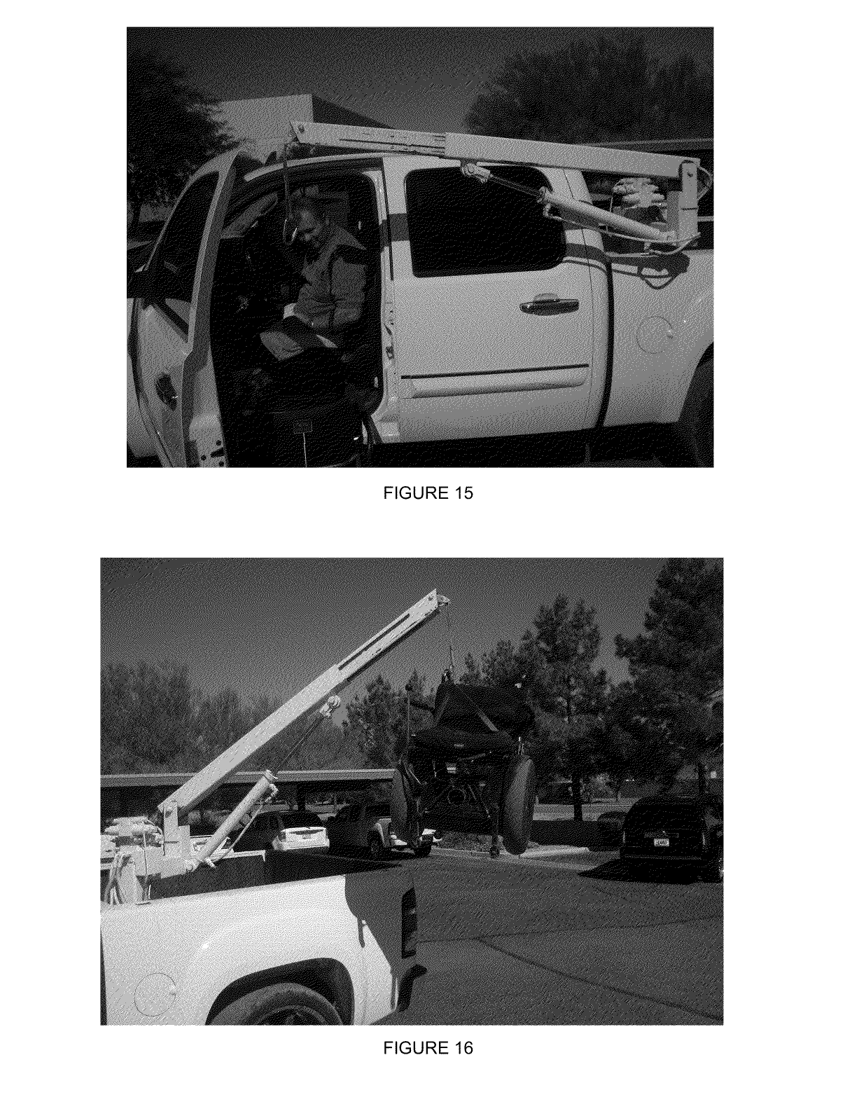

The driver can travel to the driver's side door of the truck 48, open the door and slide off his mobility device 10 and into the driver's seat. The driver can use the remote control, which can be located inside the cab of the truck 48, to rotate the lift 46 around the driver's side of the truck to the driver's side door, and lower and extend the boom 56 and boom extension link 62 so that the connection hook 50 is above the lifting strap 30 of the mobility device 10, as shown in FIG. 15. The driver can connect the connection hook 50 to the lifting strap 30 of the mobility device 10, as shown in FIGS. 6A-7B. The driver then can use the remote control to lift the mobility device 10, swivel the lift 46 towards the bed of the truck 48, as shown in FIG. 16. The driver can then retract the boom extension link 62 so that the mobility device 10 is above the truck bed and lower the boom 56 to set the mobility device 10 into the bed of the truck 48, as shown in FIGS. 8A-8B.

When the driver has reached his destination, he can use the remote control to lift the mobility device 10 out of the truck bed, since it is still attached to the lift 46, and rotate, extend, and lower the lift 46 to place the mobility device 10 just outside of the driver's side door. The driver can then remove the connection hook 50 from the lifting strap 30 and move the lift 46 out of the way (e.g., back above the truckbed). The driver can then slide into the mobility device 10, close the door and be ready for pedestrian travel.

In some embodiments, the lift 46 can have about 800 pounds of lifting capacity. In addition, the remote control can control the boom extension link 62 to allow use of the lift 46 on trucks 48 with cabs of different sizes. Further, in some embodiments, other mechanical systems, beside hydraulics, can be used to swivel, lower and raise, and extend and retract the lift 46.

For heavier loads, the lift 46 can also include a hydraulic outrigger (not shown) to stabilize the truck 48. The outrigger can be mounted to the truck frame (e.g., in the undercarriage). For example, in other embodiments, the lift 46 can be used on loads other than mobility devices 10. In one embodiment, the lift 46 can be used for loading and unloading construction materials, machinery, and other payload into and out of the bed of a truck 48 without requiring more than one person. In another embodiment, deliver companies can have a single employee perform pick-up and delivery of heavy goods without the assistance of a second employee.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A mobility device comprising:
a self-balancing mechanism;
at least one wheel operatively coupled to the self-balancing mechanism;
a mounting frame coupled to the self-balancing mechanism; and
an outrigger system, at least a portion of the outrigger system supported by the mounting frame, the outrigger system including
a stabilizer handle at least partially supported by the mounting frame,
at least one stabilizer link operatively coupled to the stabilizer handle, and
at least one stabilizer bracket operatively coupled to the at least one stabilizer link.

2. The mobility device of claim 1, and further comprising a seat coupled to the mounting frame.

3. The mobility device of claim 2, wherein the seat comprises an adjustable seat.

4. The mobility device of claim 1, wherein the at least one stabilizer bracket comprises at least one adjustable stabilizer bracket.

5. The mobility device of claim 1, wherein the at least one stabilizer bracket comprises a first, a second, a third, and a fourth stabilizer bracket; the first and the second stabilizer brackets coupled together with a first stabilizer shaft; and the third and the fourth stabilizer brackets coupled together with a second stabilizer shaft.

6. The mobility device of claim 5, wherein the outrigger system further comprises:
a first and a second intermediate shaft and an on/off link comprising an on/off bracket;
the first intermediate shaft operatively coupled to the at least one stabilizer link, the first stabilizer shaft, and the on/off link; and
the second intermediate shaft operatively coupled to the at least one stabilizer link and the second stabilizer shaft.

7. The mobility device of claim 6, and further comprising a control system, the control system comprising:
a steering linkage system at least partially supported by the mounting frame; and
a steering column directly connected to the self-balancing mechanism and operatively coupled to the steering linkage system.

8. The mobility device of claim 7, wherein the self-balancing mechanism further comprises at least one on/off switch, the on/off link is operatively coupled to the first intermediate shaft so that the on/off bracket is positioned substantially proximal to the at least one on/off switch.

9. The mobility device of claim 1, and further comprising a caster wheel operatively coupled to the at least one stabilizer bracket.

10. A mobility device comprising:
a self-balancing mechanism, the self-balancing mechanism comprising at least one on/off switch;
at least one wheel operatively coupled to the self-balancing mechanism;
a mounting frame coupled to the self-balancing mechanism; and
a control system at least partially supported by the mounting frame, the control system comprising:
a steering linkage system at least partially supported by the mounting frame; and
a steering column directly connected to the self-balancing mechanism and operatively coupled to the steering linkage system.

11. The mobility device of claim 10, and further comprising an adjustable seat coupled to the mounting frame.

12. The mobility device of claim 10, and further comprising a foot mount coupled to the mounting frame.

13. The mobility device of claim 10, and further comprising an outrigger system, at least a portion of the outrigger system supported by the mounting frame, the outrigger system including
a stabilizer handle at least partially supported by the mounting frame,
at least one stabilizer link operatively coupled to the stabilizer handle, and
at least one stabilizer bracket operatively coupled to the at least one stabilizer link.

14. The mobility device of claim 13, wherein the at least one stabilizer bracket comprises at least one adjustable stabilizer bracket.

15. The mobility device of claim 13, wherein the at least one stabilizer bracket comprises a first, a second, a third, and a fourth stabilizer bracket; the first and the second stabilizer brackets coupled together with a first stabilizer shaft; and the third and the fourth stabilizer brackets coupled together with a second stabilizer shaft.

16. The mobility device of claim 15, wherein the outrigger system further comprises:
a first and a second intermediate shaft and an on/off link comprising an on/off bracket;
the first intermediate shaft operatively coupled to the at least one stabilizer link, the first stabilizer shaft, and the on/off link, wherein the on/off link is operatively coupled to the first intermediate shaft so that the on/off bracket is positioned substantially proximal to the at least one on/off switch; and
the second intermediate shaft operatively coupled to the at least one stabilizer link and the second stabilizer shaft.

17. The mobility device of claim 16, and further comprising at least one arm rest removeably coupled to the mounting frame.

18. A method of retrofitting a mobility device, the method comprising:
providing a conventional self-balancing mobility device;
removing an element of the conventional self-balancing mobility device, the element comprising a self-balancing mechanism and at least one wheel operatively coupled to the self-balancing mechanism;
coupling a mounting frame to the element;
installing an outrigger system so that at least a portion of the outrigger system is supported by the mounting frame, the outrigger system capable of stabilizing the mobility device; and
installing a control system so that at least a portion of the control system is supported by the mounting frame, the control system capable of at least partially controlling a direction of the mobility device.

19. The method of claim 18, wherein the outrigger system comprises a stabilizer handle at least partially supported by the mounting frame, and the control system comprises a steering handle at least partially supported by the frame.

20. The method of claim 19, and further comprising coupling an adjustable seat to the mounting frame.
